(19) United States
(12) Patent Application Publication
(10) Pub. No.: US 2010/0106489 A1
(43) Pub. Date: Apr. 29, 2010

(54) Method and System for Speech Quality Prediction of the Impact of Time Localized Distortions of an Audio Transmission System

(75) Inventors: John Gerard Bereends, Hengstdijk (NL); Jeroen Martijn Van Vugt, The Hague (NL); Menno Bangma, Nootdorp (NL); Omar Aziz Niamut, Vlaardingen (NL); Bartosz Busz, Wroclaw (PL)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: KONINKLIJKE KPN N.V., The Hague (NL)

(21) Appl. No.: 12/593,654

(22) PCT Filed: Mar. 28, 2008
(86) PCT No.: PCT/EP08/02472

§ 371 Date: Sep. 29, 2009

(30) Foreign Application Priority Data
Mar. 29, 2007 (EP) 07006550.3

(51) Int. Cl. G10L 11/04

(52) U.S. Cl. 704/207; 704/E11.006

(57) ABSTRACT

Method and processing system for establishing the impact of time response distortion of an input signal which is applied to an audio transmission system (10) having an input and an output. A processor (11) is connected to the audio transmission system (10) for receiving the input signal (X(t)) and the output signal (Y(t)), and the processor (11) is arranged for outputting a time response degradation impact quality score. The processor (11) executes preprocessing of the input signal (X(t)) and output signal (Y(t)) to obtain pitch power densities (PPX(f)ₙ, PPY(f)ₙ) comprising pitch power density values for cells in the frequency (f) and time (n) domain, calculating a pitch power ratio function (PPR(f)ₙ) of the pitch power densities for each cell, and determining a on time response distortion quality score (MOSTD) indicative of the transmission quality of the system (10) from the pitch power ratio function (PPR(f)ₙ).

### FIELD OF THE INVENTION

The present invention relates to a method and a system for measuring the transmission quality of a system under test, an input signal entered into the system under test and an output signal resulting from the system under test being processed and mutually compared. More particularly, the present method relates to a method for measuring the transmission quality of an audio transmission system, an input signal being entered into the system, resulting in an output signal, in which both the input signal and the output signal are processed, comprising preprocessing of the input signal and output signal to obtain pitch power densities for the respective signals, comprising pitch power density values for time-frequency cells in the time frequency domain (f, n).

### PRIOR ART

Such a method and system are known from ITU-T recommendation P.862, “Perceptual evaluation of speech quality (PESQ), an objective method for end-to-end speech quality assessment of narrow-band telephone networks and speech codecs”, ITU-T 02.2001 [3].

Also, the article by J. Beerends et al. “PESQ, the new ITU standard for objective measurement of perceived speech quality, Part II—Perceptual model,” J. Audio Eng. Soc., vol. 50, pp. 765-778 (2002 October), describes such a method and system [2].

The invention is a further development of the idea that speech and audio quality measurement should be carried out in the perceptual domain. In general this idea results in a system that compares a reference speech signal with a distorted signal that has passed through the system under test. By comparing the internal perceptual representations of these signals, estimation can be made about the perceived quality. All currently available systems suffer from the fact that a single number is outputted that represents the overall quality. This makes it impossible to find underlying causes for the perceived degradations. Classical measurements like signal to noise ratio, frequency response distortion, total harmonic distortion, etc. pre-suppose a certain type of degradation and then quantify this by performing a certain type of quality measurement. This classical approach finds underlying causes for bad performance of the system under test but is not able to quantify the impact of the different types of distortions. The impact of linear frequency response distortions is described in a perceptual relevant manner in international patent application publication WO2006/033570. For the impact of time response distortions no solution is available yet.

### SUMMARY OF THE INVENTION

The present invention seeks to provide an improvement of the correlation between the perceived quality of speech as measured by the P.862 method and system and the actual quality of speech as perceived by test persons, specifically directed at time response distortions.

According to the present invention, a method according to the preamble defined above is provided, in which the method further comprises calculating a pitch power ratio function of the pitch power densities of the output signal and input signal, respectively, for each cell, and determining a time response distortion quality score indicative of the transmission quality of the system from the pitch power ratio function. Using this method, it is possible to quantify the relative impact of time response distortions, i.e. distortions for which subjects perceive a strong time localized distortion.

In a further embodiment, determining the time response distortion quality score comprises subjecting the pitch power ratio function (PPR(f)ₙ) to a global pitch power ratio normalization to obtain a normalized pitch power ratio function (PPR′(f)ₙ). This global normalization allows to detect both distortion due to an increase in power level (time pulse) and distortion due to a decrease in power level (time clip).

Determining the time response distortion quality score may in a further embodiment comprise logarithmically summing the normalized pitch power ratio function (PPR′(f)ₙ) per frame over all frequencies to obtain a framed pitch power ratio function (PPRₙ). In this step, the summation over the frequency domain (pitch) provides the time localized information in the time domain needed to detect time clip/time pulse type distortions.

In a further embodiment, the method further comprises determining a set of discrimination parameters, and marking a frame as time distorted (i.e. time clip or time pulse) using the set of discrimination parameters and the framed pitch power ratio function (PPRₙ). The set of discrimination parameters ensures a proper marking of frames in accordance with the type of time distortion, and allows to properly discern these type of distortions from other types of distortions, such as noise and frequency distortion.

The final quality score may be calculated according to an even further embodiment, in which the method further comprises determining the time response distortion quality score (MOSTD) by logarithmic summation of the framed pitch power ratio function (PPRₙ) over frames marked as time distorted. Furthermore, the score may be limited (e.g. to a maximum value of 1.2) and mapped to a Mean Opinion Score. This allows to provide an objective value which is suitable for comparison with subjective testing.

For the time clip embodiments, the method further comprises executing a discrimination procedure for marking a frame as time clip distorted using a global loudness parameter (LDiffAvg), a set of global power parameters (PPRDiscrₙ, PPRDiscrₚ, PPRDiscrₐₗₗ), and the pitch power ratio function in the time domain (PPRₙ). These parameters allow to properly mark a frame as time clip distorted. Calculating the global loudness parameter comprises determining an arithmic average of loudness differences (LDiffAvg) between loudness transformations (LX(f)ₙ, LY(f)ₙ) of the pitch power densities (PPX(f)ₙ, PPY(f)ₙ) over all frames in the time frequency domain for pitch frame cells in which the input signal loudness (LX(f)ₙ) is greater than the output signal loudness (LY(f)ₙ). The set of power parameters comprises a discrimination parameter for (speech) active frames (PPRDiscrₐ), a discrimination parameter for passive frames (PPRDiscrₚ) and a discrimination parameter for all frames (PPRDiscrₐₗₗ). By properly defining the parameters concerned, it is ensured that only distortions due to time clip distortions are actually accounted for, i.e. that the discrimination process is orthogonal to other types of distortions.

In a specific embodiment, a frame is marked as time clip distorted if the following conditions apply:

(LDiffAvg<first threshold value (e.g. 2.5) or PPRDiscrₐₗₗ<second threshold value (e.g. −4.0)) AND ((PPRDiscrₐₗₗ<third threshold value (e.g. 0.2) AND PPRDiscrₚ<fourth threshold value (e.g. −0.3)) or (PPRDiscrₐₗₗ<fifth threshold value (e.g. 0))). The values indicated provide a good result when applying similar steps as in the PESQ method (see e.g. ref. [1-3]).

For the time pulse embodiments, the method further comprises executing a discrimination procedure for marking a frame as time pulse distorted using a set of global power parameters (PPRDiscrₐ, PPRDiscrₚ, PPRDiscrₐₗₗ), and the pitch power ratio function in the time domain (PPRₙ). These parameters allow to properly mark a frame as time pulse distorted. The set of power parameters in these embodiments comprises a discrimination parameter for (speech) active frames (PPRDiscrₐ), a discrimination parameter for passive frames (PPRDiscrₚ) and a discrimination parameter for all frames (PPRDiscrₐₗₗ). By properly defining the parameters concerned, it is ensured that only distortions due to time pulse distortions are actually accounted for, i.e. that the discrimination process is orthogonal to other types of distortions.

In a specific embodiment, a frame is marked as time pulse distorted if:
((PPRDiscrₐₗₗ>=sixth threshold value (e.g. 1.0) and PPRDiscrₐ>seventh threshold value (e.g. −1.75)) or (PPRDiscrₐ>eighth threshold value (e.g. 1.0)) or (PPRDiscrₚ>ninth threshold value (e.g. 10.5)) or (maxFramePulseValue>tenth threshold value (e.g. 10))), in which maxFramePulseValue is a maximum value of the pitch power ratio PPRₙ over all active frames. The specific values indicated provide a good result when applying similar steps as in the PESQ method (see e.g. ref. [1-3]).

In a further embodiment, the method further comprises a compensation of the pitch power density functions of the input signal (PPX(f)ₙ) to compensate for frequency response distortions. By first compensating for frequency response distortions, a better result is obtained for determining the time clip or time pulse distortion contributions to the speech quality perception. Similarly, in a further embodiment, the method further comprises a compensation of the pitch power density functions of the input signal (PPX(f)ₙ) and output signal (PPY(f)ₙ) to compensate for noise response distortions, allowing to minimize possible errors due to noise. Also, it is possible to add a further step in an even further embodiment, in which the method comprises a compensation of the pitch power density functions of the output signal (PPY(f)ₙ) to compensate for a global power level normalization.

In a further aspect, the present invention relates to a processing system for establishing the impact of time response distortion of an input signal which is applied to an audio transmission system having an input and an output, the output of the audio transmission system providing an output signal, comprising a processor connected to the audio transmission system for receiving the input signal and the output signal, in which the processor is arranged for outputting a time response degradation impact quality score, and for executing the steps of the present method embodiments.

In an even further aspect, the present invention relates to a computer program product comprising computer executable software code, which when loaded on a processing system, allows the processing system to execute the method according to any one of the present method embodiments.

### SHORT DESCRIPTION OF DRAWINGS

The present invention will be discussed in more detail below, using a number of exemplary embodiments, with reference to the attached drawings, in which

FIG. 1 shows a block diagram of an application of the present invention; and

FIG. 2 shows a flow diagram of an embodiment according to the present invention.

### DETAILED DESCRIPTION OF EXEMPLARY EMBODIMENTS

During the past decades a number of measurement techniques have been developed that allow to quantify the quality of audio devices in a way that closely copies human perception. The advantage of these methods over classical methods that quantify the quality in terms of system parameters like frequency response, noise, distortion, etc is the high correlation between subjective measurements and objective measurements. With this perceptual approach a series of audio signals is inputted into the system under test and the degraded output signal is compared with the original input to the system on the basis of a model of human perception. On the basis of a set of comparisons the quality of the system under test can be quantified.

The perceptual model uses the basic features of the human auditory system to map both the original input and the degraded output onto an internal representation. If the difference in this internal representation is zero the system under test is transparent for the human observer representing a perfect system under test (from the perspective of perceived audio quality). If the difference is larger then zero it is mapped to a quality number using a cognitive model, allowing quantifying the perceived degradation in the degraded output signal.

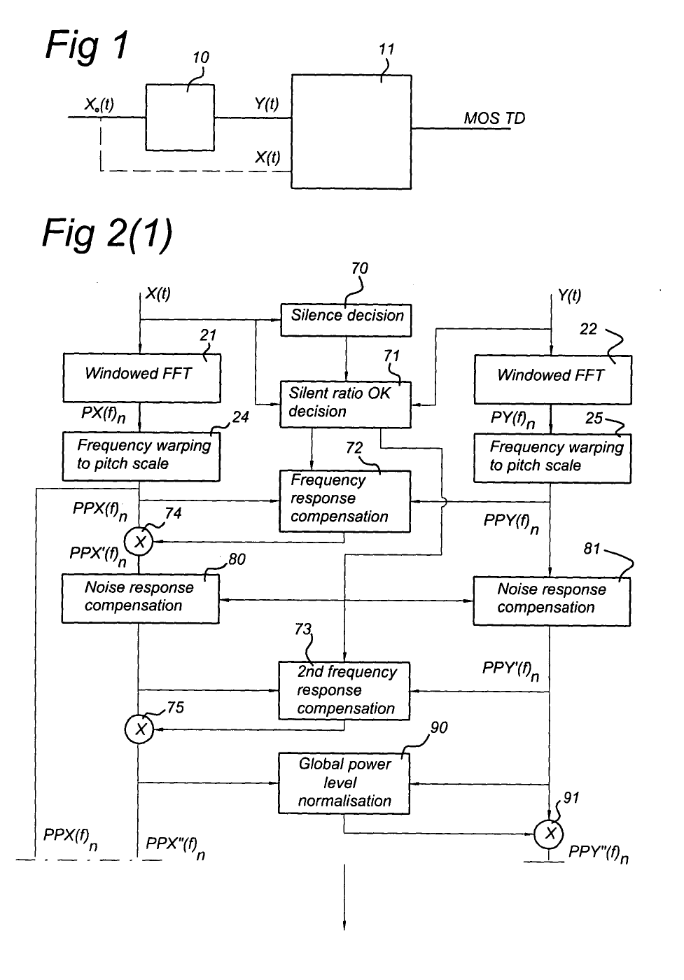

FIG. 1 shows schematically a known set-up of an application of an objective measurement technique which is based on a model of human auditory perception and cognition, and which follows the ITU-T Recommendation P.862 [3], for estimating the perceptual quality of speech links or codecs. The acronym used for this technique or device is PESQ (Perceptual Evaluation of Speech Quality). It comprises a system or telecommunications network under test 10, hereinafter referred to as system 10, and a quality measurement device 11 for the perceptual analysis of speech signals offered. A speech signal X₀(t) is used, on the one hand, as an input signal of the system 10 and, on the other hand, as a first input signal X(t) of the device 11. An output signal Y(t) of the system 10, which in fact is the speech signal X₀(t) affected by the system 10, is used as a second input signal of the device 11. An output signal Q of the device 11 represents an estimate of the perceptual quality of the speech link through the system 10.

The device 11 may comprise a dedicated signal processing unit, e.g. comprising one or more (digital) signal processors, or a general purpose processing system having one or more processors under the control of a software program comprising computer executable code. The device 11 is provided with suitable input and output modules and further supporting elements for the processors, such as memory, as will be clear to the skilled person.

Since the input end and the output end of a speech link (shown as the system 10 in FIG. 1), particularly in the event it runs through a telecommunications network, are remote, use is made in most cases of speech signals X(t) stored on data bases for the input signals of the quality measurement device 11. Here, as is customary, speech signal is understood to mean each sound basically perceptible to the human hearing, such as speech and tones. The system under test 10 may of course also be a simulation system, which e.g. simulates a telecommunications network.

A disadvantage of the perceptual approach is that is gives no insight into the underlying causes for the perceived audio quality degradation. Only a single number is output that has a high correlation with the subjectively perceived audio quality. According to the present invention it is possible to predict the quality of speech signals using ITU-T recommendation P.862 PESQ as the core algorithm [1], [2], [3] and at the same time to determine the degree in which a speech signal is affected by time distortion. Other types of underlying causes for perceived degradation of a speech signal are e.g. noise and linear frequency response distortion.

Some systems behave time variant and may introduce strong time localized errors. Examples are clicks, as found with old records, mutes, as found in packet (Voice over IP) systems, and adaptive gain control distortions. In general, these distortions have only little impact on the global frequency domain representation of the signal and cannot be interpreted as being the result of a linear time invariant system. Another view on the difference between time response and frequency response distortions is that frequency response distortions can be observed on all time limited (windowed) signal parts while time response distortions can be observed on all frequency limited signal parts. Time response distortions are becoming increasingly important in the telecommunication due to the use of packetized transport, where sometimes packets are lost (Voice over mobile, Voice over IP), and the use of automatic gain control, to compensate the large level variations as found in mobile networks.

The basic idea in the development of the time response distortion Mean Opinion Score (MOSTD) is to quantify the perceptual difference between the reference input signal and degraded output signal, only taking into account the differences based on time localized distortions. Generally, the same internal representation calculations are made as used in PESQ, i.e. time, pitch and loudness representations are used in the MOSTD score. Instead of calculating a difference function in the time, pitch domain, as used in PSQM and PESQ, a pitch power ratio function of the degraded output signal to original input signal is calculated which is used to determine the impact of time localized distortions.

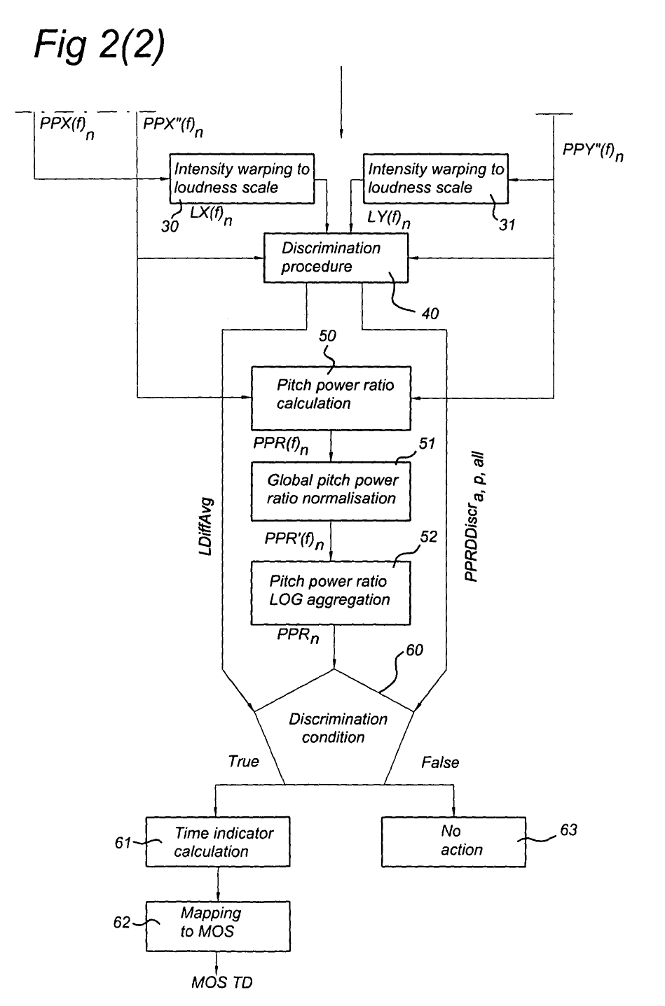

In an MOSTD scoring algorithm according to an embodiment of the present invention, as shown in the flow chart diagram of FIG. 2, the time signals X(t) and Y(t) (original and degraded signal) are transformed to time, frequency, power density functions PX(f)ₙ and PY(f)ₙ with f the frequency bin number and n the frame index (see blocks 20-22 in FIG. 2). The frequency axes are then warped in order to get the pitch power density functions PPX(f)ₙ and PPY(f)ₙ per pitch and frame cell (see blocks 23-25 in FIG. 2).

These two signals are used in the time response distortion measurement process, which is carried out in two or three steps. As a first optional step a general normalization for compensating frequency and noise response distortions and power level differences between input and output signals is executed. This optional first step will be discussed in more detail below, with reference to the blocks 70-75, 80 and 90 in FIG. 2.

In a next step, a discrimination process takes place, in which a set of discrimination parameters, different for time clip and time pulse indicator, are calculated. These discrimination parameters enable to ensure the orthogonality of the time response indicators with different types of distortion (linear frequency response and noise distortions). The set of discrimination parameters may comprise a loudness parameter and/or a plurality of power parameters.

The loudness parameter (indicated by LDiffAvg) is an arithmetic average of differences between output and input loudness over all frames in the pitch domain for cells in which the input signal loudness is greater than the output signal loudness. The set of power parameters (indicated by PPRDiscr_{a,p,all}) comes in three different flavours, one for speech active frames, one for speech passive frames and one for all (speech active and passive) frames. All three flavours are average products of the logarithmic of the pulse power ratios (PPR(f)ₙ) over respective frames (active, passive or all).

An active frame is a frame n for which the input reference signal level is above a lower power limit, and a passive frame is a frame n for which the signal level is below the lower power limit.

The key performance indicator function in embodiments of the present invention is a pitch power ratio function per pitch frame cell PPR(f)ₙ. This pitch power ratio function PPR(f)ₙ is calculated as the ratio of the output pitch power density function and input pitch power density function for each pitch frame cell (see block 50 in FIG. 2). The ratio behaviour for small values is smoothed by adding a small constant value (delta), i.e. the ratio is defined by ((PPY(f)ₙ+delta)/(PPX(f)ₙ+delta)). This pitch power ratio function PPR(f)ₙ may be normalized in a global sense, resulting in a normalized pitch power ration function (PPR′(f)ₙ, see block 51 in FIG. 2). The present invention is based on the insight that the perceptual impact of strong variations along the time axis can now be quantified by calculating a product of all ratio's in the same time frame cell (index n) over all frequency bands f (i.e. the framed pitch power ratio function PPR, see block 52 in FIG. 2).

In an embodiment of the present invention, the set of discrimination parameters and the framed pitch power ratio function PPRₙ are used to determine whether or not a frame cell in the time domain is either distorted by a time clipping or a time pulsing event, and the respective frame is marked as time clipped or time pulsed.

As a final major step, two time indicators (clip and pulse) are determined (see block 61 in FIG. 2) from the framed pitch power ratio values PPRₙ for the time clipped and/or time pulsed frames, which can then be mapped to the Mean Opinion Score for time response distortion (MOSTD, see block 62 in FIG. 2). In one embodiment, the indicator for time clipped/pulsed frames is determined as the logarithmic summation of the framed pitch power ratios of the time clipped/pulsed frames only. This indicator may then be limited to a maximum value and mapped onto a Mean Opinion Score, similar to the known PESQ methods.

In order to get a correct quantification of the impact of both time pulsing and time clipping events, a global pitch power ratio normalization (block 51 in FIG. 2) is carried out before calculating the final framed pitch power ratios (block 52 in FIG. 2). This ratio compensation is constructed separately for calculating the impact of pulse and clip type of time response distortions. Furthermore, the calculation of the set of power parameters (PPRDiscr_{a,p,all}) is different for the determination of the impact of pulse and clip type of time response distortions. This is elucidated in the following, more detailed description of embodiments of the present invention.

In the time clip indicator algorithm according to an embodiment of the present invention, two discrimination parameters are used: the loudness parameter LDiffAvg is the global loudness difference between input (LX(f)ₙ) and output (LY(f)ₙ) signals (over all time-pitch loudness density cells), and the set of power parameters PPRDiscr_{a,p,all} comprising a global log(ratio) of output (PPY″(f)ₙ) and input (PPX″(f)ₙ) pitch power densities, for the active, passive and all frames, respectively. Before calculating the first parameter, the power axes of both input (without compensation, i.e. PPX(f)ₙ) and output (with compensation, i.e. PPY″(f)ₙ) signals are warped in order to get a pitch loudness density functions LX(f)ₙ and LY(f)ₙ using the same Zwicker's transformation as the one used in ITU P.862 (see blocks 30, 31 in FIG. 2):

$${LX ( f )}_{n} = {S}_{l} \cdot {( \frac{{P}_{0} ( f )}{0.5} )}^{0.23} \cdot [ {( 0.5 + 0.5 \cdot \frac{{PPX ( f )}_{n}}{{P}_{0} ( f )} )}^{0.23} - 1 ]$$

where Sₗ is a scaling factor as defined in P.862 and P₀(f) represents the absolute hearing threshold.

After that, a global loudness compensation factor is calculated, that compensates for the overall perceived loudness difference between input and output. Next the global loudness difference is determined (block 40 in FIG. 2) as an arithmetic average of differences between output and input loudness over all frames in pitch domain LDiff(f) for pitch frame cells in which input signal loudness is greater than the output signal loudness:

$$LDiffAvg = {\sum }_{f = 0}^{Nsubset} \frac{LDiff ( f )}{{N}_{subset}}$$

where N_{subset} is a subset of all pitch bands, the set for which the input signal loudness is greater than the output signal loudness.

The second discrimination parameter comes in three different flavours, one for speech active frames (PPRDiscrₐ), one for speech passive frames (PPRDiscrₚ) and one for all, speech active and passive frames (PPRDiscrₐₗₗ). All three flavours are an average products of log(power density ratios PPR(f)ₙ) over respective frames (active, passive or all):

$${PPRDiscr}_{a , p , all} = \frac{{\sum }_{n = a , p , all} {\sum }_{f} {log}_{10} ( {PPR ( f )}_{n} )}{a , p , all}$$

where a, p, all are the numbers of active, passive, all frames respectively

The global pitch power ratio normalization for the time clip indicator is calculated from the ratio PPR(f)ₙ (calculated in block 50 in FIG. 2) differently in active and passive frames. For active frames, it is calculated over frames (time-cell) for which power ratio is between 0.2 and 5 and for which the pitch power ratio in the underlying time-frequency cells (PPY′(f)ₙ+delta/PPX″(f)ₙ+delta) is between 0.05 and 20. In passive frames the global normalizing ratio is determined only for cells for which power ratio (PPY′(f)ₙ+delta/PPX″(f)ₙ+delta) is between 0.2 and 5 (block 51 in FIG. 2). Next the ratio's are multiplied for each frame over all frequency bands (block 52 in FIG. 2) using only active time frequency cells for which the ratio is less than 1.0 (decrease in power). When the ratio PPRₙ in a frame is less than −0.2 and if discrimination condition is fulfilled, this frame is marked as a time clipped frame (in the discrimination condition block 60 in FIG. 2). The discrimination condition is constructed in a way ensuring orthogonality of the clip indicator with other distortion indicators. Two main conditions must be true to mark a frame as time clipped:
1. Global loudness difference between input and output (calculated as an average over all time-pitch loudness density cells for which the output is bigger than the input) LDiffAvg is less than a first threshold value (e.g. 2.5) or the global log(ratio) of output and input power densities over all frames (active and passive) PPRDiscrₐₗₗ is less than a second threshold value (e.g. −4.0) and,
2. Global ratio of output and input power densities over all frames PPRDiscrₐₗₗ is less than a third threshold value (e.g. 0.2) and global ratio of output and input power densities over passive frames PPRDiscrₚ is less than a fourth threshold value (e.g. −0.3) or global ratio of output and input power densities over all frames PPRDiscrₐₗₗ is less than a fifth threshold value (e.g. 0).

The first condition prevents pure linear frequency distortions (for which a global loudness difference between the input and output signals LDiffAvg is bigger than 2.5) to be considered as a clip and finds severe clip distorted signals. The second condition ensures no noise distorted signals (for which global ratio of output and input power densities over passive frames PPRDiscrₐₗₗ is greater than −0.3) to be considered as a clip.

The sum over the log(ratio's) PPRₙ in the time clipped frames (as calculated in block 61 in FIG. 2) is the indicator that correlates with the subjectively perceived impact of time response distortions for which the local loud errors are caused by a local loss of power. Next the time clip indicator value is limited to 1.2 and a 3^{rd} order mapping into a MOS scale (Mean Opinion Score five grade scale) is done (in block 62 in FIG. 2).

The key performance indicator function, the pitch power ratio PPR(f)ₙ per time pitch cell, is also used in the calculation of the time pulse indicator but using a different global pitch power ratio normalization and a different set of discrimination parameters.

In the time pulse indicator algorithm according to an embodiment of the present invention, two average normalization ratios are calculated, one over a subset of the passive frames and one over a subset of the active frames.

The passive subset consists of frames for which the input signal power is below a certain threshold, e.g. for which the frame power ratio ((output+delta)/(input+delta)) is less than 5000 (thus compensating additive noise up to a maximum level that is 5000 times a high as the input noise level) and for which the pitch power ratio in the underlying time-frequency cells, (PPY′(f)ₙ+delta/PPX″(f)ₙ+delta), is between 0.5 and 2.

The active subset consists of frames for which the input signal power is above the same criterion, for which the frame power ratio ((output+delta)/(input+delta)) is between 0.2 and 5.0 and for which the power ratio in the underlying time-frequency cells, (PPY′(f)ₙ+delta/PPX″(f)ₙ+delta), is between 0.667 and 1.5.

Discrimination parameters used in time pulse indicator calculation are only global log(ratios) of output and input power densities over active, passive and active and passive frames (PPRDiscr_{a,p,all}), as calculated in block 40 of FIG. 2. Similarly to time clip indicator, all three flavours are a products of pitch power density ratio's for which the ratio behaviour for small values is smoothed by adding a small constant, i.e. the ratio PPR(f)ₙ is defined by (output+delta)/(input+delta) over respective frames. This time, all parameters are Lₚ weighted using p=2.0, which emphasizes impact of loud pulses for each parameter:

$${PPRDiscr}_{a , p , all} = \frac{{( {\sum }_{n = a , p , all} {( {\sum }_{f} {log}_{10} ( {PPR ( f )}_{n} ) )}^{p} )}^{\frac{1}{p}}}{a , p , all}$$

with n=total number of respective frames and p=2.0.

After global pitch power ratio normalization (block 51 in FIG. 2) and discrimination process calculation (block 40 in FIG. 2), the ratios are multiplied for each frame over all frequency cells (i.e. the log aggregation of block 52 in FIG. 2). Furthermore, in this embodiment the framed pitch power ratio PPRₙ is compressed with power p=0.675, which increase the correlation of time pulse indicator with perceived speech quality:

PPR_{N}=(PPRₙ)^{P}

When the PPR_{N} after compression is bigger than 2.0 and the time pulse discrimination condition is fulfilled, the frame is marked as a time pulsed frame (see block 60 in FIG. 2). For pulse tagging, the discrimination condition has a structure as follows:

((PPRDiscrₐₗₗ>=sixth threshold value (e.g. 1.0)) and (PPRDiscrₐ>seventh threshold value (e.g. −1.75))) or
(PPRDiscrₐ>eighth threshold value (e.g. 1.0)) or
(PPRDiscrₚ>ninth threshold value (e.g. 10.5)) or
(maxFramePulseValue>tenth threshold value (e.g. 10)),
where MaxFramePulseValue parameter is a maximum value of PPR_{N} over all speech active frames before compression.

All conditions above again ensure both orthogonality of pulse indicator with other distortion indicators and high correlation with subjective perception of pulse-like distortions.

The sum over the log(ratio's) in the time pulsed frames (as calculated in block 61 in FIG. 2) is the indicator that correlates with the subjectively perceived impact of time response distortions for which the local loud errors are caused by the local introduction of power. After the time pulse indicator is calculated, its value is limited to level of 1.0 and 3^{rd} order mapping into a MOS scale is performed (see block 62 in FIG. 2).

As discussed above, the time response distortion measurement process may comprise a first step, comprising a number of compensation steps (frequency response compensation, noise response compensation and global power level normalization).

Frequency response distortions are compensated in two stages, indicated by blocks 72 and 73 in FIG. 2. The first one (block 72) takes place before noise response compensation and the second one (block 73), after it. Both stages modify only the input reference spectrum PPX(f)ₙ by multiplying (using multiplier 74, and 75, respectively) each frame of this signal PPX(f)ₙ by the ratio of output/input that is calculated as an average power of the output signal divided by an average power of the input signal. In this calculation only frames are used for which speech activity occurs (i.e. the input signal level is above a lower power limit per frame, as e.g. determined using block 70) and for which the ratio between output and input frame power (as e.g. determined in block 71) is between ⅕ and 5. This last limitation prevents compensating for time response distortions in the output signal.

Noise response distortions are compensated in both input reference PPX′(f)ₙ and output distorted PPY(f)ₙ signals (block 80 and 81, respectively) using a silent frame criterion (originating from block 71 in FIG. 2) based on the input signal power only.

First, separately for input and output signals, average power densities over passive frames (frames for which the input signal level is below a certain threshold) are calculated using an Lp weighting with p=10, only using frames for which the input to output ratio is less than 5000 (to restrict the compensation to noise only):

$${L}_{p} ( f ) = {( \frac{1}{N} {\sum }_{n = 1}^{N} {PPX ( f )}_{n}^{p} )}^{1 / p}$$

with N=total number of passive frames and p=10.

Then, for each frequency-time cell, the average power density is subtracted from actual power density to compensate for noise response distortions (blocks 80, 81). If the resulting value is smaller than 0, the power density is set to 0 and the cell represents a silence.

A global power level normalization is made only for the output signal PPY′(f)ₙ in block 90 as depicted in FIG. 2. For each speech active time frame, the output power is multiplied by a normalization factor. This normalization factor is a ratio of average input signal power to output signal power calculated over frames without time distortions, i.e. for which output signal power to input signal power ratio is greater than 0.67 and smaller than 1.5. The resulting normalization factor is bigger than 1.0 if the power level of the output signal is smaller than the power level of the input signal and smaller than 1.0 if the output signal power is bigger.

### REFERENCES INCORPORATED HEREIN BY REFERENCE

[1] A. W. Rix, M. P. Hollier, A. P. Hekstra and J. G. Beerends, “PESQ, the new ITU standard for objective measurement of perceived speech quality, Part 1—Time alignment,” J. Audio Eng. Soc., vol. 50, pp. 755-764 (2002 October).
[2] J. G. Beerends, A. P. Hekstra, A. W. Rix and M. P. Hollier, “PESQ, the new ITU standard for objective measurement of perceived speech quality, Part II—Perceptual model,” J. Audio Eng. Soc., vol. 50, pp. 765-778 (2002 October).
[3] ITU-T Rec. P.862, “Perceptual Evaluation Of Speech Quality (PESQ), An Objective Method for End-to-end Speech Quality Assessment of Narrowband Telephone Networks and Speech Codecs,” International Telecommunication Union, Geneva, Switzerland (2001 February).

1. A method for measuring a transmission quality of an audio transmission system, where an input signal is supplied to the audio transmission system and an output signal results, and where both the input signal and output signal are processed, comprising:
processing the input and output signals to obtain pitch power densities for the respective signals, the pitch power densities each including pitch power density values for cells in frequency and time domains of the respective signals;
calculating a pitch power ratio function of the pitch power densities of the output signal and input signal, respectively, for each of the cells;
determining a time response distortion quality score indicative of the transmission quality of the audio transmission system from the pitch power ratio function.

2. A method according to claim 1 in which determining the time response distortion quality score comprises subjecting the pitch power ratio function to a global pitch power ratio normalization to obtain a normalized pitch power ratio function.

3. A method according to claim 2 in which determining the time response distortion quality score further includes logarithmically summing the normalized pitch power ratio function per frame over all frequencies to obtain a framed pitch power ratio function.

4. A method according to claim 3 further comprising:
determining a set of discrimination parameters; and
marking a frame as time distorted using the set of discrimination parameters and the framed pitch power ratio function.

5. A method according to claim 4 further comprising:
determining the time response distortion quality score by a logarithmic summation of the framed pitch power ratio function over frames marked as time distorted.

6. A method according to claim 4 further comprising:
marking a frame as time clip distorted using a global loudness parameter, a set of global power parameters, and the pitch power ratio function in the time domain.

7. A method according to claim 6 wherein the global loudness parameter includes an arithmetic average of loudness differences between loudness transformations of the pitch power densities over all frames in a time frequency domain for pitch frame cells in which input signal loudness is greater than output signal loudness.

8. A method according to claim 6 in which the set of global power parameters includes a discrimination parameter for active frames, a discrimination parameter for passive frames, and a discrimination parameter for all frames.

9. A method according to claim 8 further comprising:
determining that (i) the arithmetic average of loudness differences is less than a first threshold value or the discrimination parameter for active frames is less than a second threshold value, and (ii) the discrimination parameter for all frames is less than a third threshold value and the discrimination parameter for passive frames is less than a fourth threshold value, or the discrimination parameter for all frames is less than a fifth threshold value; and
marking the frame as time clip distorted.

10. A method according to claim 4 further comprising:
executing a discrimination procedure for marking the frame as time pulse distorted using a set of global power parameters and the pitch power ratio function in a time domain.

11. A method according to claim 10 in which the set of global power parameters comprises a discrimination parameter for active frames, a discrimination parameter for passive frames, and a discrimination parameter for all frames.

12. A method according to claim 11 further comprising:
determining that (i) the discrimination parameter for all frames is greater or equal to a sixth threshold value and the discrimination parameter for active frames is greater than a seventh threshold value, (ii) the discrimination parameter for active frames is greater than an eighth threshold value, (iii) the discrimination parameter for passive frames is greater than a ninth threshold value, or (iv) a maximum value of a pitch power ratio over all active frames is greater than a tenth threshold value; and
marking the frame as time pulse distorted.

13. A method according to claim 1 further comprising:
compensating for frequency response distortions by compensation of the pitch power density functions of the input signal.

14. A method according to claim 13 further comprising:
compensating for noise response distortions by compensation of the pitch power density functions also of the output signal.

15. A method according to claim 1 further comprising:
compensating for a global power level normalization by compensation of the pitch power density functions of the output signal.

16. A processing system for establishing the impact of time response distortion of an input signal which is applied to an audio transmission system comprising:
an input line providing an audio transmission system input signal
an output line providing an audio transmission system output signal
a processor connected to the input and output lines, receiving both the input and output signals, and configured to:
process the input and output signals to obtain pitch power densities for the respective signals, the pitch power densities each including pitch power density values for cells in frequency and time domains of the respective signals;
calculate a pitch power ratio function of the pitch power densities of the output signal and input signal, respectively, for each cell; and
determine a time response distortion quality score indicative of the audio transmission quality of the system from the pitch power ratio function.

17. (canceled)

18. A computer readable medium for use in an audio transmission system, the medium containing program instructions, executable by a data processor in the system, for performing the steps of:
processing an input signal to the audio transmission system and an output signal from the audio transmission system to obtain pitch power densities for the respective signals, the pitch power densities each including pitch power density values for cells in frequency and time domains of the respective signals;
calculating a pitch power ratio function of the pitch power densities of the output signal and input signal, respectively, for each cell; and
determining a time response distortion quality score indicative of the transmission quality of the audio transmission system from the pitch power ratio function.
